(19) United States
(12) Patent Application Publication
(10) Pub. No.: US 2025/0102708 A1
(43) Pub. Date: Mar. 27, 2025

(54) Non-Fluorinated Hydrophobic Coating

(71) Applicant: HOYA Optical Labs of America, Inc., Lewisville, TX (US)

(72) Inventor: Theodore Ryan Knutson, Ramsey, MN (US)

(73) Assignee: HOYA Optical Labs of America, Inc., Lewisville, TX (US)

(21) Appl. No.: 18/896,600

(22) Filed: Sep. 25, 2024

Related U.S. Application Data
(60) Provisional application No. 63/585,160, filed on Sep. 25, 2023.

(51) Int. Cl. G02B 1/18; G02B 1/04; G02B 1/115; G02B 1/14

(52) U.S. Cl. CPC G02B 1/18; G02B 1/041; G02B 1/115; G02B 1/14

(57) ABSTRACT

An optical article comprises a coating system which provides antireflective and hydrophobic properties to the optical article. The coating system includes a hard coating on the lens substrate and alternating layers of low refractive index metal oxides and high refractive index metal oxides or alternately, mid-refractive index metal oxides and high refractive index metal oxides are deposited on the hard coating as an antireflective coating layer. A non-fluorinated hydrophobic coating compositions is deposited on the antireflective coating layer to reduce the surface free energy of the antireflective surface of the optical article and improve the overall cleanability of the lens surface by making the lens surface hydrophobic.

### RELATED APPLICATIONS

This application claims priority to U.S. Provisional Application Ser. No. 63/585,160 filed Sep. 25, 2023 entitled Non-Fluorinated Hydrophobic Coating, which is hereby incorporated herein by reference in its entirety.

### BACKGROUND

A functional coating (or multiple functional coatings) can be applied to a surface of an article to impart one or more properties or characteristics to the surface of the article. One such property or characteristic may include imparting hydrophobicity on the surface of the article. In other words, imparting hydrophobicity may generate water repellency or fog resistance characteristics to the surface of the article. Development of hydrophobic surfaces has potentially broad applications across a variety of industries including optical and non-optical related industries.

Formation of a hydrophobic surface on an optical lens has gained significant attention because the hydrophobic surface of the lens does not get wet easily due to the much higher wetting or contact angles of water droplets on such surfaces. Thus, hydrophobic surfaces prevent the accumulation of tiny water droplets on the surface which create a hazy appearance of the optical lens by way of light scattering.

In the optical industry, antireflective lens design may involve a lens base, a hard coating applied to the lens base, and alternating layers of high, middle and low refractive index metal oxides applied to the hard coating to form an antireflective stack on the lens. However, the top surface of the antireflective lens may have higher surface energy due to the tacky nature of the metal oxide surface and thus may be difficult to clean, for example, by running a cloth across the surface of the lens.

To address this problem, hydrophobic coatings have been applied on top of an antireflective coating stack in a lens to reduce the high surface energy and tackiness of the lens surface and improve the cleanability of the lens.

Current hydrophobic coatings of an optical lens comprising an anti-reflecting stack involve mostly fluorinated polymeric coatings. A fluorinated polymer containing hydrophobic coatings may be applied on the top layer of the antireflective coating stack to increase the hydrophobic nature of the top layer because such coatings reduce the surface energy of the top layer making it hydrophobic in nature.

In chemical mechanisms, these fluorinated polymeric hydrophobic coatings may utilize a silane functional group to bond to the metal/oxygen of the metal oxide layer of the antireflective coating stack. Besides a silane functional group, P═O and P—OH functional groups of the phosphonic acid of the fluorinated polymeric hydrophobic coatings may also be used for the same purpose. The silane group or P═O and P—OH functional groups form covalent or non-covalent bonds with the metal and oxygen of various metal oxides in the anti-reflecting stack of the optical lens.

However, there are significant health and environmental concerns for the application of fluorinated polymers as hydrophobic coatings because these chemicals accumulate in the body and environment, and resist degradation, thereby earning the title of “forever chemicals”.

Hence, there is a need to develop fluorine-free hydrophobic coatings which will impart hydrophobicity to the top surface of an anti-reflective stack of the optical lenses.

### SUMMARY

Systems, devices, compositions, and methods relating to the use of non-fluorinated compounds/compositions as hydrophobic coatings which can be applied on the antireflective coating stack to reduce the surface energy and improve the cleanability of the lens surface.

In one example, an antireflective lens may include a non-fluorinated hydrophobic coating on the top surface. The antireflective lens may comprise a lens substrate. The lens substrate may be coated with a hard coating to provide resistance to physical and environmental damage of the lens base. The hard coating may be further coated with multiple layers of alternating high and low refractive index metal oxides having different thicknesses to provide an antireflective stack. This antireflective stack may be coated with a non-fluorinated hydrophobic coating to reduce the surface energy and cleanability of the antireflective lens surface.

In an example, the contact angles between the top surface of the antireflective lens and the water/oil droplets may be between about 80-90° or greater than about 100°, or in between about 105-115°, or even greater than about 150° after the top surface of the antireflective stack of the lens is coated with a non-fluorinated hydrophobic coating.

In some examples, the non-fluorinated hydrophobic coating composition may comprise each one of the following compounds or any combinations thereof: PDMS-grafted phosphonic acid, Octadecylphosphonic acid, PDSM grafted silanes and n-Octadecylsilanes, wherein the silane functional groups may comprise trichlorosilane, trimethoxysilane, triethoxysilane, triisopropylsilane or any other silane derivatives capable of forming covalent or non-covalent bonds with the metal oxide layers of the antireflective stack and the polydimethylsiloxane (PDMS) portion of the PDMS-grafted phosphonic acid/PDSM grafted silanes may comprise linear or branched siloxanes.

In other example, the non-fluorinated hydrophobic coating composition may comprise another silicone component comprising both siloxane bond (Si—O) and silyl bond (Si—C), for example, hexamethyldisiloxane (HMDSO).

In some examples, the non-fluorinated hydrophobic coating of the aforementioned compositions may be applied on the top surface of the metal oxide layer of the antireflective stack of the lens by various methods known in the art, such as, for example, vacuum deposition using a chip, dip coating, spay deposition, or wiping with metal oxide surface with chemical solution.

### BRIEF DESCRIPTION OF THE DRAWINGS

The following figures are included to illustrate certain example aspects of the present disclosure and should not be viewed as exclusive or limiting. The subject matter disclosed is capable of considerable modifications, alterations, combinations, and equivalents in form and function, as will occur to one having ordinary skill in the art and having the benefit of this disclosure. The present disclosure references the drawings as follows:

FIG. 1 is a perspective view of an antireflective lens having a lens substrate, a hard coating on the lens substrate, an antireflective stack comprising low and high refractive index layers formed on the hard coating, and a hydrophobic coating deposited on top of the antireflective stack in accordance with some examples.

FIG. 2 is a perspective view of an antireflective lens having a lens substrate, a hard coating on the lens substrate, an antireflective stack comprising mid and high refractive index layers formed on the hard coating, and a hydrophobic coating deposited on top of the antireflective stack in accordance with some examples.

FIG. 3 discloses the contact angles and durability of the hydrophobicity of the surfaces after rubbing when the surface is coated with per- and polyfluoroalkyl substances (PFAS) as compared to when the surface is coated with non-fluorinated hydrophobic components as disclosed in this application in accordance with some examples.

FIG. 4 summarizes the design of experiments for the wetting contact angles (WCA) of the surface when the surface is coated with non-fluorinated hydrophobic hexamethyldisiloxane (HMDSO) as disclosed in this application in accordance with some examples.

FIGS. 5A-5C disclose variations of WCA of HMDSO as functions of different process variables as disclosed in this application in accordance with some examples. FIG. 5A discloses variations of WCA of HMDSO as a function of oxygen flow in sccm as disclosed in this application in accordance with some examples. FIG. 5B discloses variations of WCA of HMDSO as a function of ion beam current (A) as disclosed in this application in accordance with some examples. FIG. 5C discloses variations of WCA of HMDSO as a function of HMDSO flow in sccm as disclosed in this application in accordance with some examples.

FIG. 6 summarizes measurement of WCA of HMDSO after rubbing test and acetone cleaning test as disclosed in this application in accordance with some examples.

### DETAILED DESCRIPTION

It will be appreciated by persons skilled in the art that the present disclosure is not limited to what has been particularly shown and described herein. A variety of modifications and variations are possible in view of the teachings herein without departing their scope, spirit, or intent.

While different examples may be described in this specification, it is specifically contemplated that any of the features from the different examples can be used and brought together in any combination. In other words, the features of different examples can be mixed and matched with each other. Hence, while every permutation of features from different examples may not be explicitly shown or described, it is the intention of this disclosure to cover any such combinations, especially as may be appreciated by one of skill in the art.

The terminology used in this disclosure should be interpreted in a permissive manner and is not intended to be limiting. In the drawings, like numbers refer to like elements. Unless otherwise noted, all of the accompanying drawings are not to scale. Unless otherwise noted, the term “about” is defined to mean plus-or-minus 10% of a stated value.

An optical lens may comprise a lens substrate. Non-limiting examples of the lens substrate may comprise glass, polymer, or other materials suitable for forming a lens base. The lens substrate may be coated with a hard coating to provide resistance to physical and environmental damage of the lens base and improve its strength and durability. The surface of the hard coating may further be coated with multiple layers of transparent materials with alternating low and high refractive index metal oxides having different thicknesses. Alternately, the surface of the hard coating may further be coated with multiple layers of transparent materials with alternating mid and high refractive index metal oxides having different thicknesses. These alternating low and high or mid and high refractive index metal oxides may reduce the excess reflected light on the surface of the lens and thus form an antireflective lens comprising the antireflective stack of the metal oxides on the hard coating.

The antireflective stack of the optical lens may be coated with a hydrophobic coating to reduce the overall surface energy of the lens. In some examples, the desirable hydrophobic coating comprises non-fluorinated hydrophobic coating.

In some examples, the antireflective optical lens may be an ophthalmic lens.

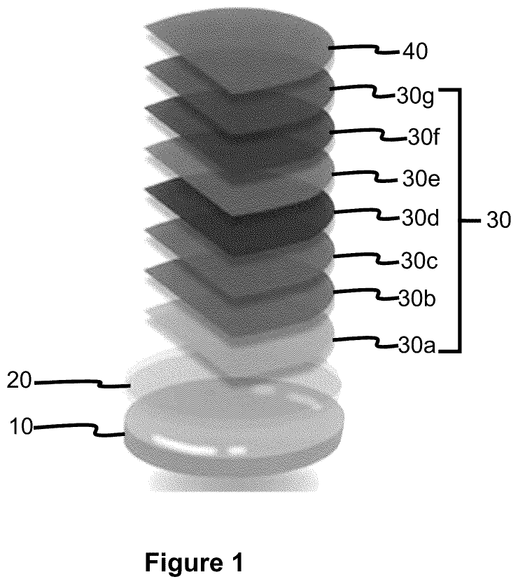

FIG. 1 illustrates an example in which a lens substrate 10 (e.g., of an optical lens) may be coated with a hard coating 20 to provide resistance to the physical and environmental damage of the lens base and improve its strength and durability. The surface of hard coating 20 may be coated with a durable anti-reflective coating 30 to reduce the reflection from the lens surface.

As shown in FIG. 1, the antireflective coating 30 may comprise a multi-layer stack (e.g., seven layers, more than seven layers, or less than seven layers) of alternating L/H/L/H/L/H/L layers, where L may comprise a low refractive index layer (30a, 30c, 30e, 30g) and H may comprise a high refractive index layer (30b, 30d, 30f). The final layer 30g of the antireflective coating may be further coated with a non-fluorinated hydrophobic coating 40. However, other layer configurations may be utilized in different examples, including an inverse configuration of layers.

In some other examples, the anti-reflective stack 30 may employ, for example, less than or more than seven layers of alternating low and high index refractive layers as shown in FIG. 1. The number of alternating low and high index refractive layers may not necessarily be limited, and any numbers of alternating low and high index refractive layers may form the antireflective stack. In this respect, the stack may have layers 30n where n equals the number of layers present.

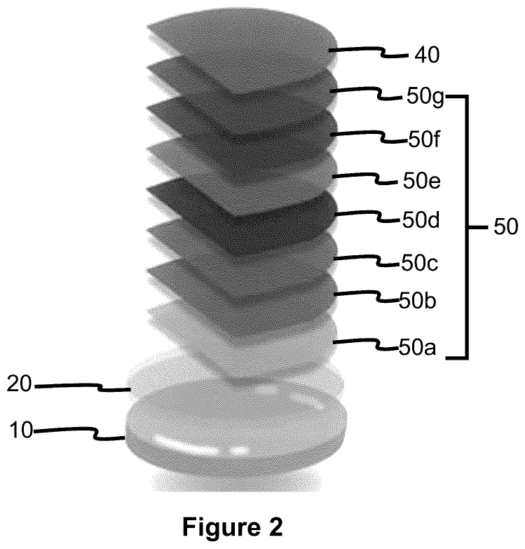

The order of the stacking of the low refractive index layer (L) and high refractive index layer (H) may not be limited to L/H/L/H/L/H/L, as shown in FIG. 1. In some examples, the order of the stacking of the low refractive index layer (L) and high refractive index layer (H) may be H/L/H/L/H/L/H. In such order of stacking, the surface of hard coating 20 is coated with a high refractive index layer (H) and the final coating of the anti-reflecting stack 30 may also be a high refractive index layer (H). FIG. 2 illustrates an example in which a lens substrate 10 (e.g., of an optical lens) may be coated with a hard coating 20 to provide resistance to physical and environmental damage of the lens base and improve its strength and durability. The surface of hard coating 20 may be coated with a durable anti-reflective coating 50 to reduce the reflection from the lens surface.

As shown in FIG. 2, the antireflective coating 50 may comprise a multi-layer stack (e.g., seven layers, more than seven layers, or less than seven layers) of alternating M/H/M/H/M/H/M layers, where M may comprise a mid-refractive index layer (50a, 50c, 50e) and H may comprise a high refractive index layer (50b, 50d, 50f). The final layer 50g of the antireflective coating is further coated with a non-fluorinated hydrophobic coating 40.

In some other examples, the anti-reflective stack 50 may employ, for example, less than or more than seven layers of alternating mid and high index refractive layers. The number of alternating mid and high index refractive layers may not necessarily be limited, and any numbers of alternating mid and high index refractive layers may form the antireflective stack. In this respect, the stack may have layers 50n where n equals the number of layers present.

The order of the stacking of the mid refractive index layer (M) and high refractive index layer (H) may not be limited to M/H/M/H/M/H/M, as shown in FIG. 2. In some examples, the order of the stacking of the mid refractive index layer (M) and high refractive index layer (H) may be H/M/H/M/H/M/H. In such order of stacking, the surface of hard coating 20 is coated with a high refractive index layer (H) and the final coating of the anti-reflecting stack 50 may also be a high refractive index layer (H).

For the sake of clarity, as used herein, the term high refractive index or high index, may include an index of refraction that is approximately greater than about 1.9 at a referenced wavelength, for example a wavelength of about 550 nanometers. The term low refractive index, or low index, may include an index of refraction that is approximately less than about 1.55 at a referenced wavelength, for example a wavelength of about 550 nanometers. The term mid-refractive index, or mid-index, may include an index of refraction approximately between about 1.55 and 1.9 at a referenced wavelength, for example a wavelength of about 550 nanometers.

In some examples, the low refractive index materials may include, for example, silicon dioxide (SiO₂) or any other metal oxides having refractive index lower than about 1.55 at a referenced wavelength of about 550 nanometers. In some examples, the mid-refractive index materials may include aluminum oxide (Al₂O₃) or any other metal oxides having refractive index approximately between about 1.55 and 1.9 at a referenced wavelength of about 550 nanometers. Some suitable materials for high index metal oxides may include various metal oxides such as titanium dioxide (TiO₂), zirconium dioxide (ZrO₂), niobium pentoxide (Nb₂O₅), tantalum pentoxide (Ta₂O₅), zinc oxide (ZnO₂), indium oxide (In₂O₃), and hafnium oxide (HfO₂) as well as any other transition or non-transition metal oxides having refractive index of greater than 1.9 at a referenced wavelength of about 550 nanometers.

The chemical property of the metal oxide surfaces of the antireflective stack are generally hydrophilic in nature due to the presence of metal cations and oxygen anions, which can interact with the protons/hydroxyl groups or polar groups of the water/oil molecules making the surface tacky such that the water/oil droplets may spread across the surface making the surface difficult to clean by running a cloth across the surface.

Hence, it would be desirable to coat the top metal oxide surface of the antireflective stack with a hydrophobic coating such that the contact angles between the top surface of the antireflective stack of the lens and the water/oil droplets are, for example, greater than about 90°. Surfaces with contact angles greater than about 90° is the characteristic of hydrophobic surfaces. On such surfaces, the water/oil droplets may tend to bead up instead of spreading across the surface of the antireflective lens.

In some examples, the contact angles between the top surface of the antireflective lens and the water/oil droplets may be between about 80-90° or greater than about 100°, or in between about 105-115°, or even greater than about 150° after the top surface of the antireflective stack of the lens is coated with a non-fluorinated hydrophobic coating. The hydrophobic coating on the antireflective stack should have little to no effect on the reflection performance of the antireflective lens so as to minimize or eliminate the cleanability problem associated with the hydrophilic surface of the antireflective stack.

Disclosed herein are one or more hydrophobic coatings comprising non-fluorinated components; thus, avoiding the use of fluorinated chemicals which may accumulate in the body and environment and show resistance to degradation.

In some examples, the hydrophobic coating may comprise a non-fluorinated active component which comprises functional groups capable of forming, for example, covalent or non-covalent bonds with the metal oxide layers of the antireflective stack. In some non-limiting examples, the functional groups of the non-fluorinated active component may comprise non-limiting functional derivatives of organophosphonic acid and/or silanes.

In some examples, the covalent or non-covalent bond strength (i.e., adhesion strength) between the metal oxides of the top layer of antireflective coating 30, as shown in FIG. 1, and the functional groups of the non-fluorinated active components comprising functional derivatives of organophosphonic acid and/or silanes increases when the top layer of antireflective coating 30 comprises a high refractive index layer (H) instead of a low refractive index layer (L).

In some other examples, the covalent or non-covalent bond strength (adhesion) between the metal oxides of the top layer of antireflective coating 50 and the functional groups of the non-fluorinated active components comprising functional derivatives of organophosphonic acid and/or silanes increases when the top layer of antireflective coating 50 comprises a high refractive index layer (H) instead of a mid-refractive index layer (M).

In some examples, a thin high refractive index layer (H) may be used to promote stronger covalent or non-covalent bonding between the metal oxides of the top layer of antireflective coating 30 or the metal oxides of the top layer of antireflective coating 50 and the functional groups of the non-fluorinated active components comprising functional derivatives of organophosphonic acid and/or silanes. In some examples, the thickness of such thin high refractive index layer (H) is in a range of 0.1 nm-150 nm. In some other examples, the thickness of such thin high refractive index layer (H) is in a range of 1 nm-80 nm.

In some examples, the functional groups of the non-fluorinated hydrophobic compounds may comprise silicone polymers, for example, polydimethylsiloxane (PDMS) grafted silanes, for example, PDMS-grafted triethoxysilane and n-octadecylsilanes.

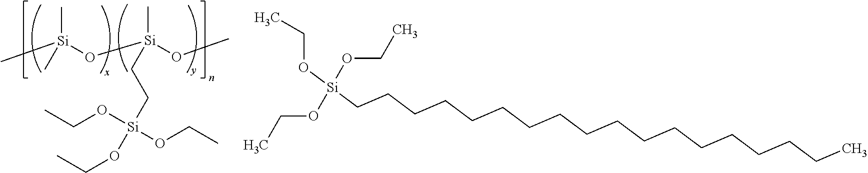

In PDMS-grafted silanes and n-octadecylsilanes, the silane functional groups may form the covalent or non-covalent bonds with the metal oxide layers of the antireflective stack. Some non-limiting examples of the silane functional groups may comprise trichlorosilane, trimethoxysilane, triethoxysilane, triisopropylsilane or any other silane derivatives capable of forming covalent or non-covalent bonds with the metal oxide layers of the antireflective stack. In some examples, the polydimethylsiloxane (PDMS) portion of the PDMS-grafted silanes may comprise linear or branched siloxanes.

In some examples, the non-fluorinated hydrophobic coating may comprise a single compound such as a PDMS-grafted silane, for example, a PDMS-grafted triethoxysilane. In other examples, the non-fluorinated hydrophobic coating may comprise a combination of compounds such as a PDMS-grafted silane and n-octadecylsilane. In some examples, the silane functional group of the PDMS-grafted silane and n-octadecylsilane may comprise a triethoxysilane. In such examples, the hydrophobic coating composition may comprise a combination of PDMS-grafted triethoxysilane and n-Octadecyltriethoxysilane.

However, it should be appreciated that the combinations of reagents are not limited to PDMS-grafted triethoxysilane and n-Octadecyltriethoxysilane. Any other combinations of the silane functional groups of the PDMS-grafted silane and/or n-octadecylsilane comprising trichlorosilane, trimethoxysilane, triisopropylsilane or any other silane derivatives capable of forming covalent or non-covalent bonds with the metal oxide layers of the antireflective stack may be utilized. In some examples, one or more combinations of the silane derivatives of PDMS-grafted silanes and n-octadecylsilanes may be combined in a mixture and deposited on the top surface of the antireflective stack of the lens for increasing the contact angles of the water/oil droplets and improving the durability, cleanability, and overall performance of the antireflective lens.

In some examples, the functional groups containing non-fluorinated hydrophobic compounds may comprise phosphonic acid derivatives, for example, polydimethylsiloxane (PDMS) grafted phosphonic acid and n-octadecyl phosphonic acid.

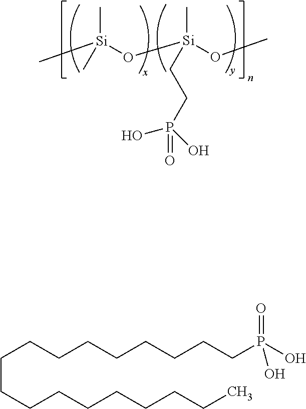

In PDMS-grafted phosphonic acid and n-octadecyl phosphonic acid, the phosphonic acid functional groups may form the covalent or non-covalent bonds with the metal oxide layers of the antireflective stack. In some examples, the polydimethylsiloxane (PDMS) portion of the PDMS-grafted phosphonic acid may comprise linear or branched siloxanes.

In some examples, the non-fluorinated hydrophobic coating containing phosphonic acid derivative may comprise a single compound such as a PDMS-grafted phosphonic acid, for example, a linear or branched PDMS-grafted phosphonic acid. In some other examples, the hydrophobic coating may comprise a combination of reagents such as a PDMS-grafted phosphonic acid and n-octadecylphosphonic acid.

In some examples, a linear PDMS-grafted phosphonic acid may be combined with a n-octadecylphosphonic acid to form the hydrophobic coating. In some other examples, a branched PDMS-grafted phosphonic acid can be combined with n-octadecylphosphonic acid to form the hydrophobic coating. In some examples, the linear PDMS-grafted phosphonic acid, branched PDMS-grafted phosphonic acid may be combined with n-octadecylphosphonic acid to form the hydrophobic coating. In some examples, the PDMS-grafted phosphonic acid and n-octadecyl phosphonic acid may be combined in a mixture and deposited on the top surface of the antireflective stack of the lens for increasing the contact angles of the water/oil droplets and improving the durability, cleanability, and overall performance of the antireflective lens.

According to some examples, the non-fluorinated hydrophobic coating composition may comprise combinations of PDMS-grafted phosphonic acid and a PDMS-grafted silanes, wherein the silane functional groups of the PDMS-grafted silanes may comprise trichlorosilane, trimethoxysilane, triethoxysilane, triisopropylsilane or any other silane derivatives capable of forming covalent or non-covalent bonds with the metal oxide layers of the antireflective stack and the polydimethylsiloxane (PDMS) portion of the PDMS-grafted silane may comprise linear or branched siloxanes. In such examples, the phosphonic acid functional groups of PDMS-grafted phosphonic acid may also form the covalent or non-covalent bonds with the metal oxide layers of the antireflective stack and the PDMS portion of the PDMS-grafted phosphonic acid may comprise linear or branched siloxanes.

In some other examples, the non-fluorinated hydrophobic coating composition may comprise different combinations of a PDMS-grafted phosphonic acid and n-Octadecylsilanes, wherein the silane functional group of the n-Octadecylsilanes may comprise trichlorosilane, trimethoxysilane, triethoxysilane, triisopropylsilane or any other silane derivatives capable of forming covalent or non-covalent bonds with the metal oxide layers of the antireflective stack and the polydimethylsiloxane (PDMS) portion of the PDMS-grafted phosphonic acid may comprise linear or branched siloxanes.

According to further examples, the non-fluorinated hydrophobic coating composition may comprise combinations of Octadecylphosphonic acid and PDMS-grafted silanes, wherein the silane functional groups of the PDMS-grafted silanes may comprise trichlorosilane, trimethoxysilane, triethoxysilane, triisopropylsilane or any other silane derivatives capable of forming covalent or non-covalent bonds with the metal oxide layers of the antireflective stack and the polydimethylsiloxane (PDMS) portion of the PDMS-grafted silanes may comprise linear or branched siloxanes.

The non-fluorinated hydrophobic coating composition may comprise different combinations of Octadecylphosphonic acid and n-Octadecylsilanes, wherein the silane functional groups of the n-Octadecylsilanes may comprise trichlorosilane, trimethoxysilane, triethoxysilane, triisopropylsilane or any other silane derivatives capable of forming covalent or non-covalent bonds with the metal oxide layers of the antireflective stack.

According to some other examples, the non-fluorinated hydrophobic coating composition may comprise each one of the compound or any possible combinations of PDMS-grafted phosphonic acid, Octadecylphosphonic acid, PDSM grafted silanes and n-Octadecylsilanes, wherein the silane functional groups may comprise trichlorosilane, trimethoxysilane, triethoxysilane, triisopropylsilane or any other silane derivatives capable of forming covalent or non-covalent bonds with the metal oxide layers of the antireflective stack and the phosphonic acid functional groups of PDMS-grafted phosphonic acid may also form the covalent or non-covalent bonds with the metal oxide layers of the antireflective stack. In such examples, the polydimethylsiloxane (PDMS) portion of the PDMS-grafted phosphonic acid/PDSM grafted silanes may comprise linear or branched siloxanes.

In some other examples, the phosphonic acid functional groups of the Octadecylphosphonic acid and PDMS-grafted phosphonic acid may make enhanced covalent or non-covalent bonds with the antireflective stack, when the antireflective stack includes mid-high refractive index metal oxides (M/H/M/H/M/H/M etc) over the low refractive index metal oxide, as shown in FIG. 2. In some examples, suitable mid refractive index metal oxide can be aluminum oxide (Al₂O₃) or any other metal oxides having refractive index approximately between about 1.55 and 1.9 at a referenced wavelength of about 550 nanometers. Some suitable examples of high refractive index layers may include various metal oxides such as titanium dioxide (TiO₂), zirconium dioxide (ZrO₂), niobium pentoxide (Nb₂O₅), tantalum pentoxide (Ta₂O₅), zinc oxide (ZnO₂), indium oxide (In₂O₃), and hafnium oxide (HfO₂) as well as any other transition or non-transition metal oxides having refractive index of greater than 1.9 at a referenced wavelength of about 550 nanometers. In some examples, the low refractive index materials may include, for example, silicon dioxide (SiO₂) or any other metal oxides having refractive index lower than about 1.55 at a referenced wavelength of about 550 nanometers. In some other examples, the silane functional groups of the PDSM grafted silane and n-Octadecylsilane may make enhanced covalent or non-covalent bonds with the antireflective stack, when the antireflective stack includes mid-high refractive index metal oxides (M/H/M/H/M/H/M etc) over the low refractive index metal oxide, as shown in FIG. 2. In some examples, suitable mid refractive index metal oxide can be aluminum oxide (Al₂O₃) or any other metal oxides having refractive index approximately between about 1.55 and 1.9 at a referenced wavelength of about 550 nanometers. Some suitable examples of high refractive index layers may include various metal oxides such as titanium dioxide (TiO₂), zirconium dioxide (ZrO₂), niobium pentoxide (Nb₂O₅), tantalum pentoxide (Ta₂O₅), zinc oxide (ZnO₂), indium oxide (In₂O₃), and hafnium oxide (HfO₂) as well as any other transition or non-transition metal oxides having refractive index of greater than 1.9 at a referenced wavelength of about 550 nanometers. In some examples, the low refractive index materials may include, for example, silicon dioxide (SiO₂) or any other metal oxides having refractive index lower than about 1.55 at a referenced wavelength of about 550 nanometers.

In some other examples, the phosphonic acid functional groups of the Octadecylphosphonic acid and PDMS-grafted phosphonic acid may form stronger covalent and non-covalent bonds with a mid-refractive index metal oxide, for example, aluminum oxide (Al₂O₃), as compared to a low refractive index metal oxide, for example, silicon dioxide (SiO₂) when used as the top metal oxide layer of the antireflective stack, as shown in FIG. 2 of this application.

It should be appreciated that the functional groups of the non-fluorinated hydrophobic coating compounds may not be limited to the silicone polymers, for example, polydimethylsiloxane (PDMS) grafted silanes, and n-octadecylsilanes and/or phosphonic acid derivatives, for example, polydimethylsiloxane (PDMS) grafted phosphonic acid and n-octadecyl phosphonic acid, as previously indicated. In some examples, linker molecules and coupling agents may be chosen based on the functional groups present in the silicone polymers and polymers of the phosphonic acid derivative to be combined with these linker molecules and coupling agents to modify the desired properties and the processing conditions of the final hydrophobic coating material.

Some non-limiting examples of the linker molecules are isocyanates, for example but not limited to, toluene diisocyanate (TDI), methylenediphenyl diisocyanate (MDI), hexamethylene diisocyanate (HDI); epoxy group containing molecules, for example but not limited to Bisphenol A diglycidyl ether (BADGE); anhydrides and acid chlorides, for example but not limited to, phthalic anhydride, succinic anhydride, terephthaloyl chloride; azides and alkynes containing molecules, for example but not limited to, azide-functionalized polymers and alkyne-functionalized polymers and aminosilanes, for example but not limited to, γ-Aminopropyltriethoxysilane (APTES).

In some examples, the isocyanates may react with hydroxyl, amine, or carboxyl groups of the non-fluorinated hydrophobic coating compounds to form urethane or urea linkages.

In some examples, the epoxy group containing molecules may react with amine, hydroxyl, and carboxyl groups of the non-fluorinated hydrophobic coating compounds to form strong covalent bonds.

In some examples, the anhydrides and acid chlorides may react with the hydroxyl or amine groups of the non-fluorinated hydrophobic coating to form ester or amide bonds.

In some examples, the azides and alkynes containing molecules may form triazole linkages with the non-fluorinated hydrophobic coating through click chemistry.

In some examples, the aminosilanes may be used as a functional group on the non-fluorinated hydrophobic coating to modify the surfaces and improve the adhesion between the non-fluorinated hydrophobic polymers and inorganic fillers from the antireflecting stack.

Some non-limiting examples of the coupling agents may comprise silane coupling agents, for example but not limited to, vinyltrimethoxysilane, γ-methacryloxypropyltrimethoxysilane (MPS), γ-glycidoxypropyltrimethoxysilane (GPS), γ-aminopropyltriethoxysilane (APTES). The silane coupling agents may be used to bond with the inorganic materials (like glass fibers) to organic polymers such as the non-fluorinated hydrophobic polymers.

In vinyltrimethoxysilane, a vinyl group (C═C) attached to a silicon atom, which is bonded to three methoxy groups (—OCH₃). In vinyltrimethoxysilane, the vinyl group may be used to bond to the PDMS or alkyl functionality of the non-fluorinated hydrophobic polymers through another reactive group.

In γ-aminopropyltriethoxysilane (APTES), a three-carbon chain containing propyl group is linked with an amine group (—NH₂) at one end of a silicon atom and three ethoxy groups (—OCH₂CH₃) are attached with the rest of the arms of the silane atom.

In γ-aminopropyltriethoxysilane (APTES), the amine group may be used to bond to the PDMS or alkyl functionality of the non-fluorinated hydrophobic polymers through another reactive group.

In some examples, the non-fluorinated hydrophobic coating of the aforementioned compositions may be applied on the top surface of the metal oxide layer of the antireflective stack of the lens by various methods known in the art, such as, for example, vacuum deposition using a chip, dip coating, spay deposition, or wiping with metal oxide surface with chemical solution.

In some examples, the non-fluorinated hydrophobic compound/compositions comprising the functional groups of organophosphonic acid and/or silanes for the purpose of bonding or interacting with the antireflective stack may be vacuum deposited on the top surface of the metal oxide layer of the antireflective stack of the lens using a vacuum coater.

In some examples, PDMS-grafted triethoxysilane may be vacuum deposited on the top surface of the metal oxide layer of the antireflective stack of the lens to provide contact angles in a range of 102.3 to 107.4.

In some other examples, a solution of the hydrophobic compound/compositions comprising the functional groups of organophosphonic acid and/or silanes for the purpose of bonding or interacting with the antireflective stack may be sprayed on the top surface of the metal oxide layer of the antireflective stack of the lens.

According to some examples, the top surface of the metal oxide layer of the antireflective stack of the lens may impregnated with a chemical wipe deposition of the hydrophobic compound/compositions comprising the functional groups of organophosphonic acid and/or silanes for the purpose of bonding or interacting with the antireflective stack.

In some examples, the chemical wipe deposition of the non-fluorinated hydrophobic compound/compositions on the antireflective stack may be performed immediately after the deposition of the antireflective stack on the hard coating of the lens substrate. In some other examples, when the chemical wipe deposition of the non-fluorinated hydrophobic compound/compositions on the antireflective stack may not be performed immediately after the deposition of the antireflective stack, repetition of the chemical wipe deposition of the non-fluorinated hydrophobic coating may be needed. In some examples, the hydrophobic lens surface may be refreshed via a chemical solution containing wipes comprising PDMS-grafted silane, for example, PDMS-grafted triethoxysilane. According to some other examples, organosilicon components comprising both siloxane bond (Si—O) and silyl bond (Si—C) may be deposited as a non-fluorinated hydrophobic coating on the top metal oxide surface of the antireflective stack of the lens.

In some examples, such silicon components comprising both the siloxane and silyl bonds may include hexamethyldisiloxane (HMDSO). HMDSO may be deposited as a non-fluorinated hydrophobic coating on the top metal oxide surface of the antireflective stack of the lens to make the surface hydrophobic. HMDSO is an organosilicon dimer composed of siloxane (Si—O) bonds and methylsilyl (Si—CH₃)ₓ groups.

HMDSO may be considered as a potential hydrophobic coating because of its attractive properties, such as, e.g., scratch protection, anti-corrosion protection, water permeation barrier, lower refractive index of about 1.4, which may be improve efficiency of the hydrophobic coating compound. Moreover, HMDSO has been reported to exhibit contact angles from 100-140°, which are desirable characteristics for a highly efficient hydrophobic coating. Decomposition and deposition conditions of HMDSO may result in a film with different attributes.

HMDSO may be deposited on the antireflective stack by using plasma-based techniques, such as APCVD and PECVD. Plasma polymerization may be an essential process to create a hard scratch resistance like quartz with high hydrophobicity.

According to some examples, the siloxane and silyl groups of HMDSO may be capable of forming covalent or non-covalent bonds with the metal oxide layers of the antireflective stack when the antireflective stack includes low and high refractive index metal oxides (L/H/L/H/L/H/L etc), as shown in FIG. 1.

In some other examples, the siloxane and silyl groups of HMDSO may make enhanced covalent or non-covalent bonds with the antireflective stack, when the antireflective stack includes mid and high refractive index metal oxides (M/H/M/H/M/H/M etc.) over the low refractive index metal oxide, as shown in FIG. 2.

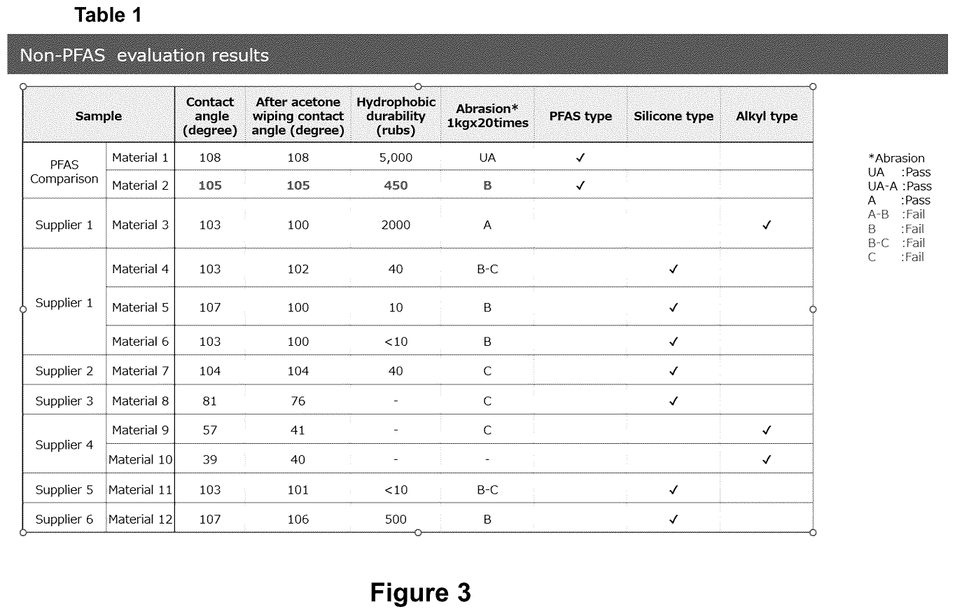

As can be seen from table 1 and FIG. 3, the non-fluorinated hydrophobic components comprising derivatives of organophosphonic acid and/or silanes may be coated on the top surface of the metal oxide layer of the antireflective stack to provide contact angles in a range of about 102 to 107. This range of contact angles of the non-fluorinated hydrophobic coating is comparable to the contact angles of the market available fluorinated hydrophobic coatings, such as, per- and polyfluoroalkyl substances (PFAS).

In some examples, the durability of the non-fluorinated hydrophobic coating, for example, an alkyl chain containing non-fluorinated hydrophobic coating, is comparable to the durability of the fluorinated hydrophobic coating PFAS, as disclosed in table 1 of FIG. 3. Such durability tests of the hydrophobic surfaces were performed by rubbing the hydrophobic surfaces. In some examples, the non-fluorinated hydrophobic compound coated surface comprises contact angle of about 103 after rubbing the surface about 2000 times. In some other examples, the non-fluorinated hydrophobic compound coated surface comprises contact angle of about 107 after rubbing the surface about 500 times. It should be appreciated that contact angles above 90 degrees are the characteristic of a hydrophobic surface.

According to some examples, the abrasion resistance of the non-fluorinated hydrophobic coating, for example, an alkyl chain containing non-fluorinated hydrophobic coating, shows comparable abrasion resistance performance in comparison to the fluorinated hydrophobic coating PFAS, as disclosed in table 1 of FIG. 3.

In one example, a non-fluorinated hydrophobic coating, for example, an alkyl chain containing non-fluorinated hydrophobic coating, provides comparable durability (2000 rubs) and abrasion resistance (A) of the hydrophobic coating as compared to the durability and abrasion resistance of the fluorinated hydrophobic coatings or PFAS, for example, material 1 of PFAS [hydrophobic durability: 5000 rubs, abrasion: UA] and material 2 of PFAS [hydrophobic durability: 450 rubs, abrasion: B], as disclosed in table 1 of FIG. 3.

Table 1 of FIG. 3 further disclose that in some other examples, the non-fluorinated hydrophobic coating compositions comprising the silicone components may provide contact angles in a range of 102-107, which is the characteristic of a hydrophobic surface, after rubbing the surface in a range of 10-40 times.

In some examples, the non-fluorinated hydrophobic coating comprising, for example, hexamethyldisiloxane (HMDSO) may show wide ranges of wetting contact angles (WCA) depending on the different process variables at which the WCA experiments are performed.

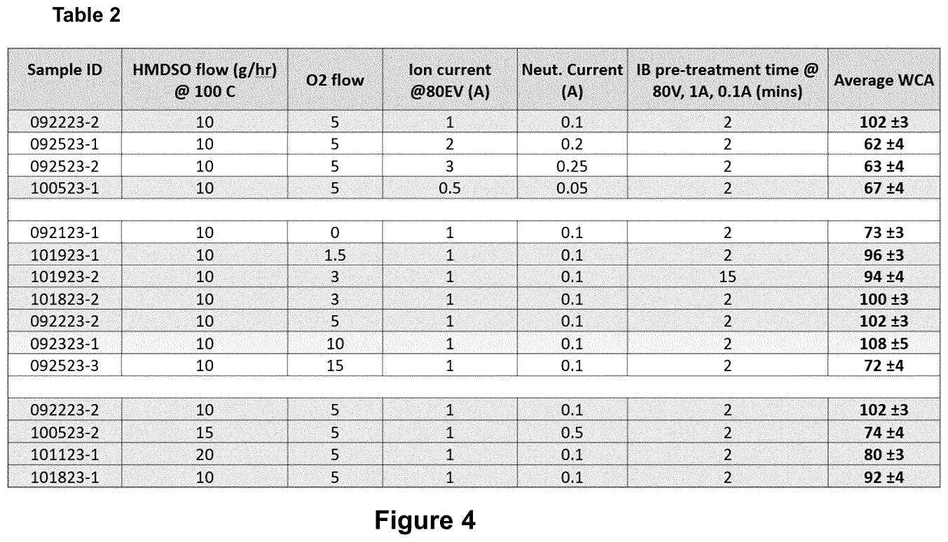

Table 2 in FIG. 4 summarizes experiments for the WCA of the surface when the surface is coated with non-fluorinated HMDSO. In some examples, the average WCA is obtained after measuring the samples three times at different spots.

As can be seen from table 2 in FIG. 4, the WCA obtained is in a range of 62±4 degrees to 108±5 degrees with different variables of HMDSO flow rate, oxygen flow rate, ion current, neutral current and ion beam pre-treatment time in minutes. In some examples, WCA of about 108±5 degrees may be obtained when the HMDSO flow rate and the oxygen flow rate are about 10 sccm, the ion current is about 1 A at 80 EV, the neutral current is about 0.1 A and the ion beam pre-treatment time at 80V, 1 A, 0.1 A is about 2 minutes.

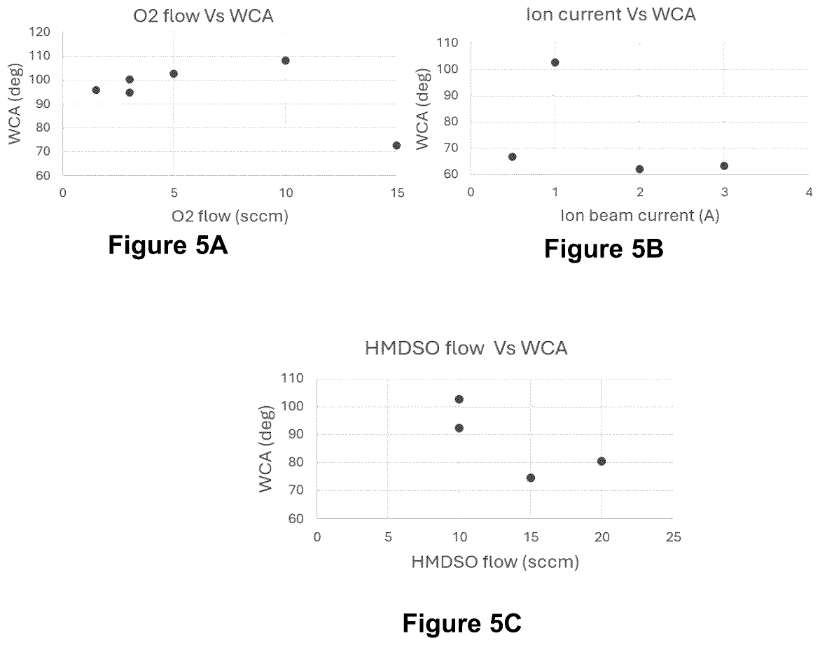

FIG. 5A discloses variations of WCA of HMDSO as a function of oxygen flow in sccm. In some examples, obtaining a higher WCA, for example a WCA of about 110 degrees, requires an optimum number between the ratio of HMDSO flow rate and oxygen flow rate. In some examples, the higher WCA of about 110 degrees was obtained when the ratio between the HMDSO flow rate and the oxygen flow rate is about 1, as shown in table 2, FIG. 4 and FIG. 5A.

FIG. 5B discloses variations of WCA of HMDSO as a function of ion beam current (A). The plot in FIG. 5B discloses that a higher WCA, for example a WCA of about 100 degrees of HMDSO, is sensitive to the plasma conditions. In some examples, a WCA of about 100 degrees of HMDSO may be obtained with an ion beam current of about 1.0 A.

FIG. 5C discloses variations of WCA of HMDSO as a function of HMDSO flow in sccm. In some examples, a higher WCA, for example a WCA of about 100 degrees of HMDSO, is obtained with the oxygen flow rate of about 10 sccm.

In some examples, the surface of the non-fluorinated hydrophobic coating may be rubbed with cheese cloth or cleaned with acetone to test the durability of the hydrophobic coating.

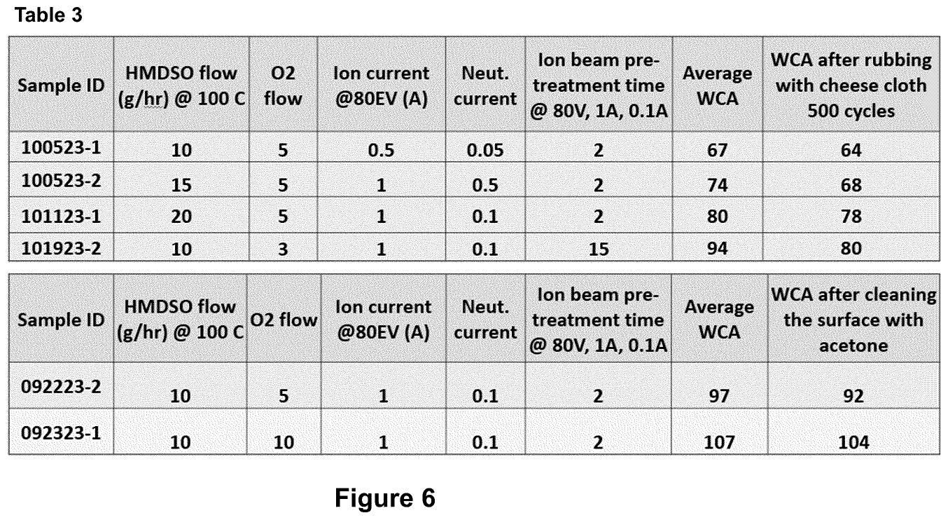

Table 3 in FIG. 6 summarizes measurement of WCA of HMDSO coated surface after rubbing tests with cheese cloth and acetone cleaning tests are performed.

In some examples, the WCA of HMDSO coated surface may decrease after rubbing and acetone cleaning tests. In some non-limiting examples, the range of decrease may be from 2 to 14 for rubbing tests and from 3 to 5 for acetone cleaning tests.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A non-fluorinated hydrophobic coating composition comprising one or more of the following compounds:
a PDMS-grafted phosphonic acid, an Octadecylphosphonic acid, a PDSM grafted silane, and/or a n-Octadecylsilane.

2. The non-fluorinated hydrophobic coating composition of claim 1, wherein the one or more compounds of the PDMS-grafted phosphonic acid, the Octadecylphosphonic acid, the PDSM grafted silane, and/or the n-Octadecylsilane are deposited on an antireflective stack of an optical article.

3. The non-fluorinated hydrophobic coating composition of claim 2, wherein a silane functional group of the PDSM grafted silane or the n-Octadecylsilane and a phosphonic acid functional group of the PDMS-grafted phosphonic acid or the Octadecylphosphonic acid are configured to form bonding with a metal oxide layer of the antireflective stack.

4. The non-fluorinated hydrophobic coating composition of claim 2, wherein the antireflective stack of the optical article comprises at least a high refractive index metal oxide layer and at least a low refractive index metal oxide layer.

5. The non-fluorinated hydrophobic coating composition of claim 2, wherein the antireflective stack of the optical article comprises at least a high refractive index metal oxide layer and at least a mid-refractive index metal oxide layer.

6. The non-fluorinated hydrophobic coating composition of claim 5, wherein the silane functional group of the PDSM grafted silane or the n-Octadecylsilane and the phosphonic acid functional group of the PDMS-grafted phosphonic acid or the Octadecylphosphonic acid are configured to form enhanced bonding with the antireflective stack of the optical article comprising the high refractive index metal oxide layer and the mid-refractive index metal oxide layer.

7. The non-fluorinated hydrophobic coating composition of claim 3, wherein the silane functional group of the PDSM grafted silane or the n-Octadecylsilane comprises trichlorosilane, trimethoxysilane, triethoxysilane or triisopropylsilane.

8. The non-fluorinated hydrophobic coating composition of claim 3, wherein a structure of the PDMS-grafted phosphonic acid or the PDSM grafted silane comprises a linear PDMS or a branched PDMS.

9. The non-fluorinated hydrophobic coating composition of claim 1, wherein a contact angle between the non-fluorinated hydrophobic coating and a water droplet is greater than 90°.

10. The non-fluorinated hydrophobic coating composition of claim 1, further comprising a dimeric silane.

11. The non-fluorinated hydrophobic coating composition of claim 10, wherein the dimeric silane is hexamethyldisiloxane.

12. The non-fluorinated hydrophobic coating composition of claim 11, wherein the dimeric silane comprising hexamethyldisiloxane exhibits a contact angle in a range of 100-140°.

13. An antireflective article, comprising:
a substrate;
a hard coating deposited on the substrate;
an antireflective layer is deposited on the hard coating; and
a non-fluorinated hydrophobic coating composition is deposited on the antireflective layer; and,
wherein the non-fluorinated hydrophobic coating composition comprises at least one of a PDSM grafted silane; a n-Octadecylsilane; a PDMS-grafted phosphonic acid, and/or an Octadecylphosphonic acid.

14. The non-fluorinated hydrophobic coating composition of claim 13, wherein a silane functional group of the PDSM grafted silane and/or the n-Octadecylsilane and a phosphonic acid functional group of the PDMS-grafted phosphonic acid or the Octadecylphosphonic acid are configured to form bonding with a metal oxide layer of the antireflective stack.

15. The non-fluorinated hydrophobic coating composition of claim 13, wherein a silane functional group of the PDSM grafted silane and/or the n-Octadecylsilane and a phosphonic acid functional group of the PDMS-grafted phosphonic acid or the Octadecylphosphonic acid are configured to form bond with linker molecules and coupling agents to modulate properties of the non-fluorinated hydrophobic coating composition.

16. The non-fluorinated hydrophobic coating composition of claim 15, wherein the coupling agents to modulate the properties of the non-fluorinated hydrophobic coating composition comprises silane coupling agents comprising vinyltrimethoxysilane, γ-methacryloxypropyltrimethoxysilane (MPS), γ-glycidoxypropyltrimethoxysilane (GPS) or γ-Aminopropyltriethoxysilane (APTES).

17. The non-fluorinated hydrophobic coating composition of claim 15, wherein the linker molecules to modulate the properties of the non-fluorinated hydrophobic coating composition comprises isocyanates, epoxy group containing molecule, anhydrides, acid chlorides, azides, alkynes or amino silanes.

18. A method of coating a non-fluorinated hydrophobic layer on an antireflective stack of an optical lens, comprising:
coating a lens base with a hard coating;
depositing the antireflective stack on the hard coating; and
disposing a non-fluorinated hydrophobic coating on a top surface of the antireflective stack to form the non-fluorinated hydrophobic layer on a top surface of the optical lens.

19. The method of claim 18, wherein disposing the non-fluorinated hydrophobic layer on the top surface of the antireflective stack further comprises disposing the hydrophobic coating through vacuum deposition using a chip, dip coating, spay coating or wiping the top surface of the antireflective stack with a solution comprising the hydrophobic coating.

20. The method of claim 18, wherein disposing the non-fluorinated hydrophobic coating on the top surface of the antireflective stack further comprises disposing at least one component from the following: a PDMS-grafted phosphonic acid, an Octadecylphosphonic acid, a PDSM grafted silane or a n-Octadecylsilane.
